(19) United States
(12) Patent Application Publication
(10) Pub. No.: US 2006/0041912 A1
(43) Pub. Date: Feb. 23, 2006

(54) Method and apparatus for authorizing an additional set-top device in a satellite television network

(76) Inventor: Kevin Kuhns, Suwanee, GA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/119,501

(22) Filed: Apr. 29, 2005

Related U.S. Application Data
(60) Provisional application No. 60/602,846, filed on Aug. 19, 2004.

(51) Int. Cl. H04N 7/20; H04N 7/18

(52) U.S. Cl. 725/71; 725/80; 725/81; 725/31

(57) ABSTRACT

The present invention is a method and apparatus for authorizing an additional set-top device in a location with an existing authorized set-top device without the need to connect the two devices via a dedicated wired connection. After the additional set-top device is connected to the satellite television network, for example through a coaxial cable used to deliver satellite television signals, the existing set-top device is designated as a master set-top device. The additional set-top device is then authenticated as a slave set-top device via the connection to the satellite television network. In one embodiment, an intelligent bridge, which is preferably a QUAD LNB, authorizes the slave set-top device after receiving the master set-top device indication and the slave set-top device presence indication. Alternatively, in a repeater embodiment, a repeater may be used for signal routing only and slave authentication is accomplished in the master set-top device.

### FIELD OF THE INVENTION

The present invention relates to the field of satellite television networks, and more particularly, to a method and apparatus for authorizing an additional set-top device at a specific subscriber location in a satellite television network.

### BACKGROUND OF THE INVENTION

Since its introduction in the late 1980's, satellite television has become an integral part of home entertainment. Frequently, satellite subscribers initiate their satellite television service by installing only one set-top device in the home. Later, after growing attached to the additional programming and variety of other benefits offered by satellite television, satellite subscribers usually desire to add a further set-top device in other rooms of their home.

Typically, a service provider for satellite television service assumes that the customer will pay the full service fee per month for selected programming for the first master set-top device, also referred to as the “existing” set-top device, installed in the home. Additional set-top devices are often offered at no extra charge, or for a small additional monthly fee. This allocation of set-top devices to customers and the resulting revenue from the master set-top devices form the basis of the service provider's business. Once installed, if the additional set-top devices can be easily relocated, then the service provider loses potential revenue. Therefore, the service provider must ensure that the additional set-top devices cannot easily be physically relocated to other potential customer locations and function as master set-top devices.

However, several of the methods available for installing an additional set-top device are ridden with drawbacks and the potential for this type of fraud. For example, FIG. 1 illustrates a typical master-slave method 100 for installing an additional set-top device in a subscriber location 120. Subscriber location 120 comprises a single location authorized for receiving a signal from the satellite television network via antenna 112, such as a single family residence.

The master-slave method 100 utilizes RS232 connectors 104 and 106 on the backs of the existing set-top device 102 and the additional set-top device 108, respectively. A multipair cable 114 then connects the existing set-top device 102 and the additional set-top device 108 via the RS232 connectors 104 and 106, respectively. The additional set-top device 108 then may receive programming from antenna 112 only as long as cable 114 is connected to the RS232 connector 106 and an authentication message is periodically exchanged over the RS232 link between the existing set-top device 102 (as the master set-top device) and the additional set-top device 108 (as the slave set-top device). Hereinafter, the existing set-top device may be interchangeably referred to as the “master set-top device.” Furthermore, the additional set-top device may be interchangeably referred to as the “slave set-top device.” This logical connection between the master set-top device and the slave set-top device establishes the master-slave relationship between the two devices and ensures that the slave set-top device cannot be relocated and used as a stand-alone master.

While thousands of additional set-top devices all over the world are installed in this manner, this master-slave method is riddled with drawbacks. First, dwellings in many parts of the world are composed of concrete walls. Thus, in order to connect the existing set-top device with the additional set-top device, assuming the additional set-top device is in a different room, a hole must be created in one or more walls to lay the multipair RS232 cable. Not only is such a hole time consuming to create in concrete, the hole also permanently blemishes the appearance of the concrete wall.

Another drawback with this master-slave method is that only one additional set-top may be added in this manner. With only one additional set-top device capable of being physically connected to the master set-top device, the customer is unable to add any more additional set-top devices. Thus, the service provider loses the potential for any further revenue from the subscriber location after the first additional set-top device is installed.

Furthermore, as part of the logical master-slave mating process, the technician installing the additional set-top device must call the satellite television provider to supply a long digit-string serial number located in the exterior body of the additional set-top device. The service provider then supplies the technician with a long numeric authentication key, which the technician must then key into the additional set-top device to authorize programming to the additional set-top device. While this process may take a short amount of time in some areas of the world, in regions where concrete walls are commonplace and phone service is unpredictable, this process may take several hours, or even an entire day, to complete. Thus, many consumers with these drawbacks are discouraged with the master-slave method, which in turn, discourages the sale of additional set-top devices.

Another method for connecting an existing set-top device with an additional set-top device involves the use of a telephone line in the home that enables the set-top device to dial into an authentication server at a distant location using an 800 number service. By employing automatic number identification at the authentication server end, existing and additional set-top devices can be authenticated based upon the fact that they dial in from a known telephone number. Unfortunately, many satellite television customers around the world do not have local telephone service, or the service is unreliable, or there is not an 800 number service available. Thus, this method proves to be problematic in many parts of the world.

Thus, there is a need in the art for a method and apparatus for installing an additional set-top device that does not require the existing authorized set-top device and the additional set-top device to be linked via a separate wired connection. There is also a need in the art for a method and apparatus for installing an additional set-top device that does not require the technician installing the additional set-top device to contact the satellite television service provider via telephone to complete the installation process.

### SUMMARY OF THE INVENTION

The present invention overcomes these and other disadvantages in the prior art by providing a method and apparatus for authorizing an additional, or slave, set-top device in a subscriber location with an existing, or master, set-top device without the need to connect the additional set-top device and the master set-top device via a separate wired connection. A bridge located in the outdoor receiving unit (“ORU”) forwards communications between the master set-top device and the slave set-top device. In a QUAD LNB embodiment, this bridge comprises a QUAD LNB in the ORU, and slave authentication is performed in the QUAD LNB. In a repeater embodiment, this bridge comprises a repeater comprising software to enable communication of messages between the master set-top device and the slave set-top device, and slave authentication is performed in the master set-top device.

### BRIEF DESCRIPTION OF THE DRAWINGS

For a fuller understanding of the present invention, reference is made to the following description taken in connection with the accompanying drawings, in which:

FIG. 1 is a simplified block diagram illustrating a prior art master-slave system for installing an additional set-top device in a subscriber location.

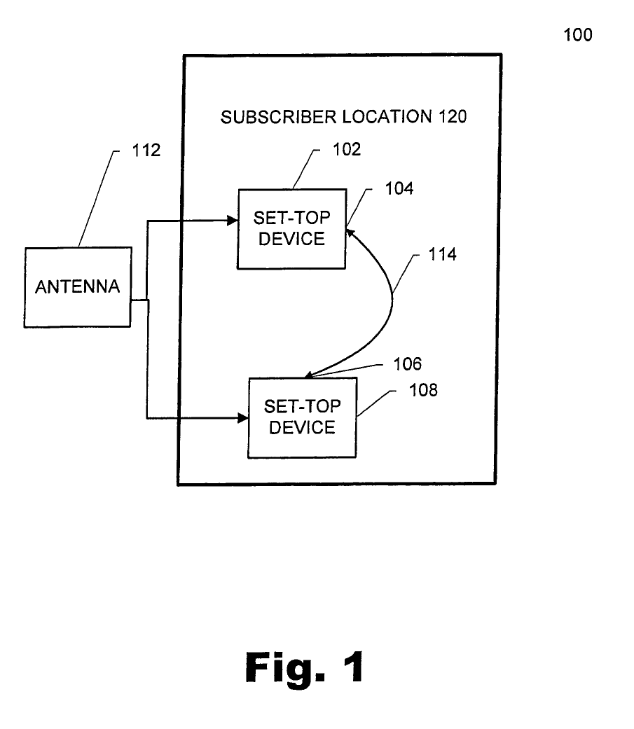

FIG. 2 is a block diagram illustrating an exemplary system for installing an additional set-top device in accordance with an embodiment of the present invention.

FIG. 3 is a flow diagram illustrating the method of authorizing an additional set-top device in accordance with an embodiment of the present invention from the perspective of the system.

FIG. 4 is a flow diagram illustrating the method of authorizing an additional set-top device in accordance with an embodiment of the present invention from the perspective of the bridge.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention.

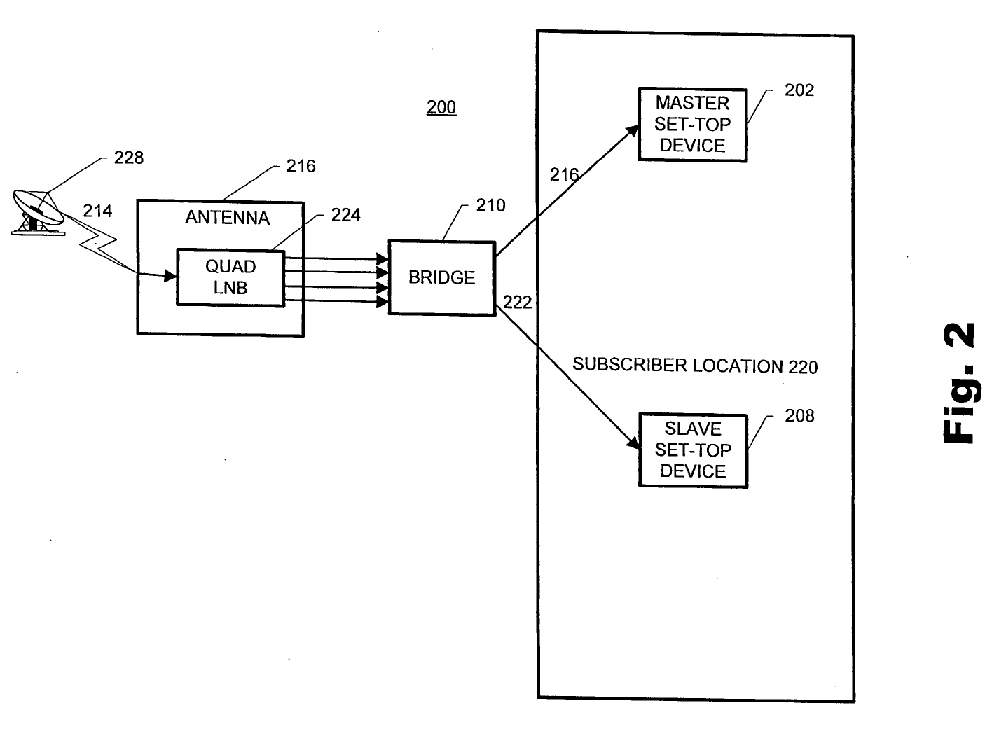

FIG. 2 is a block diagram illustrating system 200 in accordance with an embodiment of the present invention. Master set-top device 202 and slave set-top device 208 are located within the same subscriber location 220, and are communicatively coupled to bridge 210. Master set-top device 202 and slave set-top device 208 may also be communicatively coupled to a telephone line (not pictured).

Antenna 216 is also communicatively coupled to bridge 210, and propagates satellite television signal 214 to system 200. Signal 214 comprises content received from a satellite source, such as satellite television content.

Antenna 216 comprises four low-noise block downconvertors 224 (hereinafter referred to as a “QUAD LNB 224”). The QUAD LNB 224 is placed in the focal point of antenna 216 and converts the signal 214 into an L Band Intermediate frequency signal. L-band comprises the group of radio frequencies extending from 390 MHz to 1550 MHz.

The QUAD LNB 224 also comprises a DiSEqC (Digital Satellite Equipment Control) receiver, which is configured to receive DiSEqC messages. DiSEqC messages are sent as sequences of short bursts of 22 kHz pulse-width modulated tone carried by the coax cable between the QUAD LNB and the subscriber location 220. In a QUAD LNB embodiment, bridge 210 comprises the QUAD LNB 224, and provides a simple combining of the DiSEqC signals between the master set-top device 202 and the slave set-top device 208. As a result, DiSEqC signals originating from the master set-top device 202 are bridged and forwarded to the slave set-top device 208.

However, in the repeater embodiment, bridge 210 comprises a repeater external to the QUAD LNB 224. In the repeater embodiment, bridge 210 comprises software to enable the successful direction of messages between the master set-top device 202 and the slave set-top device 208.

Thus, in system 200, any DISEqC signal originating from any slave set-top device, albeit slave set-top device 208 or any other set-top device within subscriber location 220, will be bridged and forwarded to the master set-top device 202. Each of these messages comprise a number of digital bytes of eight bits each. Each bit of each message occupies a specific time and the proportion of that time filled with the 22 kHz burst determines whether that bit is a 1 or a 0. The messages between the master set-top device 202 and the slave set-top device 208 may comprise information necessary for enabling the slave set-top device 208 to receive signal 214. This information may include, but is not limited to, serial number information and authentication keys from master set-top device for the slave set-top device 208. However, in the repeater embodiment, the authentication of the slave set-top device 208 is performed within the master set-top device 202.

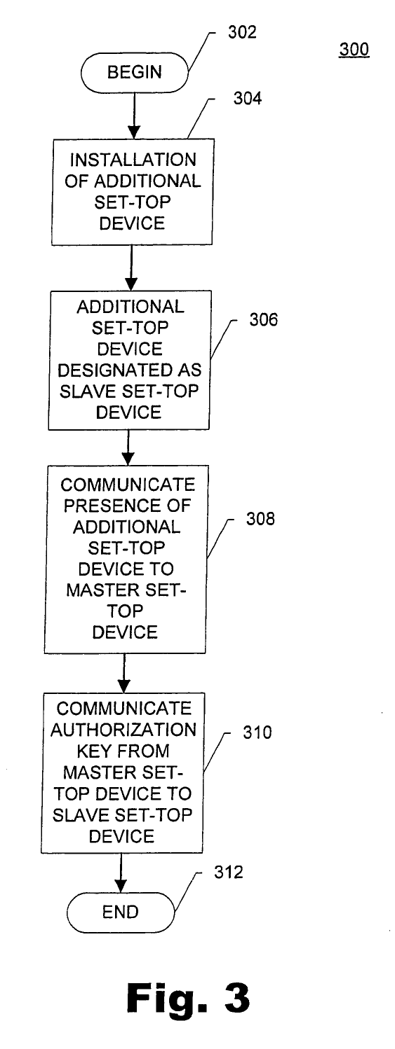

FIG. 3 is a flow diagram illustrating the method of authorizing an additional set-top device in accordance with an embodiment of the present invention from the perspective of the system. Method 300 begins at step 302 and proceeds to the installation of the additional set-top device at step 304. This step 304 involves connecting the additional set-top box to a connection to the satellite television network, such as a coaxial cable outlet in the wall of a residence in a subscriber location.

Next, at step 306, the additional set-top device is designated as the slave set-top device 208. This designation may be effectuated in several ways, including but not limited to, entering a key sequence on the additional set-top device or actuating a button on the external body of the additional set-top device. This step 306 may also involve an inverse process, i.e., designation of the existing set-top device as the master set-top device, by any of the aforementioned methods.

At step 308, the presence of the slave set-top device 208 is communicated to the master set-top device 202. This receipt of the slave presence indication may take place at the same time, or at a different point of time, from the receipt of a master indication at step 404. This slave presence indication may comprise any signal, but is preferably a DiSEqC signal associated with information indicating the presence of a slave set-top device 202 in the subscriber location 220. Furthermore, this slave presence indication is preferably generated by the slave set-top device, but may be generated by another device capable of determining the presence of the slave set-top device in the communications network.

At step 310, the master set-top device 202 communicates an authorization key to the slave set-top device 208. This authorization key may comprise any security mechanism or message sufficient to authorize the slave set-top device 208 to receive programming from satellite television signal 214, and is preferably communicated via a DiSEqC signaling protocol. Furthermore, this authorization key is preferably generating by the master set-top device, but may be generated by any device capable of determining the status of authorization for the slave set-top device to receive signal 228. Method 300 then concludes at step 312.

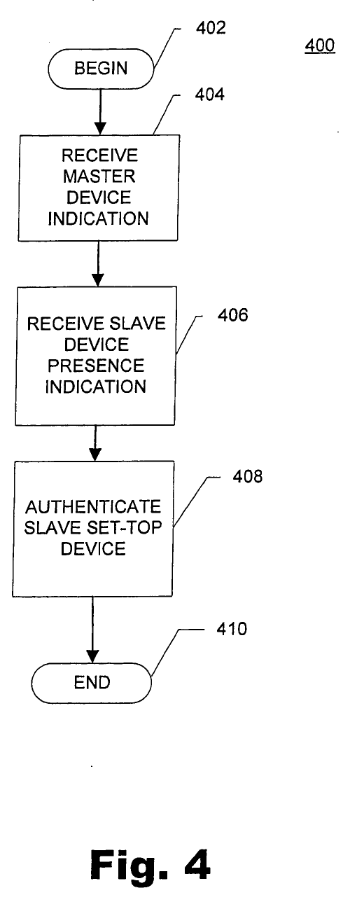

FIG. 4 is a flow diagram illustrating the method of authorizing an additional set-top device in accordance with an embodiment of the present invention from the perspective of the bridge 210. As stated in the description of FIG. 2, in the QUAD LNB embodiment of the present invention, which is the preferred embodiment, the bridge 210 may comprise the QUAD LNB 224. Alternatively, in the repeater embodiment of the present invention, the bridge 210 comprises a repeater positioned between the QUAD LNB 224 and subscriber location 220.

Method 400 begins at step 402 and proceeds to the receipt of master indication at step 404. This master indication may originate from the master set-top device, and preferably is in response to a signal received by the master set-top device. For example, the master set-top device may generate the master indication after receiving a particular signal, such as a key sequence or actuation of a dedicated button, from an external device, such as a remote control.

At step 406, the bridge 210 receives a slave presence indication. This receipt of the slave presence indication may take place at the same time, or at a different point of time, from the receipt of a master indication at step 404. This slave presence indication is preferably a DiSEqC signal, and is associated with information indicating the presence of a slave set-top device in the subscriber location. Furthermore, this slave presence indication is preferably generated by the slave set-top device, but may be generated by any device capable of recognizing the presence of the slave set-top device in system 200.

Next, at step 408, the slave set-top device 208 is authenticated, which may involve any transmission or process to effectively enable the slave set-top device to receive the signal from the satellite television network 214. In the repeater embodiment of the present invention, this step is performed exclusively within the master set-top device 202.

Preferably, authenticating the slave set-top device 208 comprises the master set-top device 202 generating one or more authentication keys. These authentication keys are forwarded to the slave set-top device 208 via the bridge 210. These authentication keys preferably comprise information, in the form of a DiSEqC protocol, necessary to enable slave set-top device 208 to receive signal 214, including but not limited to, serial number information. Method 400 concludes at step 410 after authentication of the slave set-top device 208.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable carrier” for purposes of embodiments of the present invention may be any medium or transmission that can contain, store, communicate, propagate, or transport the program for use by or in connection with the instruction execution system, apparatus, system or device. The computer readable carrier can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear. As used in the description herein and throughout the claims that follow, “a” , “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims.

What is claimed is:

1. A method for providing communication between a master set-top device and a slave set-top device located within a subscriber location in a satellite television receiving terminal comprising a receiving unit, said method comprising the steps of:
communicating messages between the master set-top device and the slave set-top device via a bridge;
wherein said bridge is located within the ORU, and said slave device is authenticated via said messages.

2. The method of claim 1, wherein communicating messages between the master set-top device and the slave set-top device via a bridge comprises communicating messages from the slave set-top device to the master set-top device.

3. The method of claim 1, wherein communicating messages from the master set-top device to the slave set-top device via a bridge comprises communicating messages from the master set-top device to the slave set-top device via an intelligent bridge.

4. The method of claim 3, further comprising communicating messages from the slave set-top device to the master set-top device via the intelligent bridge.

5. The method of claim 1, wherein communicating messages from the master set-top device to the slave set-top device comprises communicating messages from the master set-top device to the slave set-top device via a repeater.

6. The method of claim 5, further comprising communicating messages from the slave set-top device to the master set-top device via a repeater.

7. A system for authorizing a slave set-top device in a subscriber location comprising a master set-top device to receive a signal from a satellite television network, said apparatus comprising:
an existing set-top device;
an additional set-top device; and
a bridge for receiving communications between the existing set-top device and the additional set-top device;
wherein said system designates the existing set-top device as a master set-top device; and authenticates the additional set-top device as a slave set-top device.

8. The system of claim 7, wherein the bridge comprises an intelligent bridge for receiving communications between a master set-top device and a slave set-top device.

9. The system of claim 8, wherein said intelligent bridge comprises a QUAD LNB.

10. The system of claim 7, wherein the bridge comprises a repeater coupled to the slave set-top device and the master set-top device.

11. The system of claim 10, wherein said authentication of the additional set-top device as a slave device occurs within the master set-top device.

12. The system of claim 7, wherein authentication of the additional set-top device as a slave device comprises communication of serial number information.

13. The system of claim 7, wherein authentication of the additional set-top device as a slave device comprises communication of one or more authentication keys.

14. The system of claim 7, wherein said master set-top device is communicatively coupled to a telephone line.

15. An apparatus for providing communication between a master set-top device and a slave set-top device in a satellite television network, said apparatus comprising:
a communication link to a master set-top device, wherein the slave set-top device may generate communications for the slave set-top device;
a communication link to a slave set-top device, wherein the slave set-top device may generate communications for the master set-top device; and,
a communication protocol for communicating with a master set-top device and a slave set-top device;
wherein said apparatus receives a master indication; receives a slave presence indication; and authorizes slave set-top device.

16. The apparatus of claim 15, wherein said communication protocol is DiSEqC signaling protocol.

17. The apparatus of claim 15, wherein authorization of said slave set-top device comprises instructing the master set-top device to generate an authorization key.

18. The apparatus of claim 17, wherein said apparatus comprises a bridge.

19. The apparatus of claim 15, wherein authorization of said slave set-top device comprises instructing generating an authorization key and communicating the authorization key to the slave set-top device.

20. The apparatus of claim 19, wherein said apparatus comprises a QUAD LNB.

21. A computer readable carrier including computer program instructions that instruct a computer to perform the steps of:
receiving a master set-top device indication;
receiving a slave set-top device presence indication; and
authorizing a slave set-top device;
wherein said master set-top device and slave set-top device are coupled to a satellite television network.

22. The computer readable medium of claim 21, wherein said receiving a master set-top device indication comprises receiving a slave set-top device presence indication.

23. The computer readable medium of claim 21, wherein said receiving a slave set-top device presence indication comprises receiving serial number information for said slave set-top device.

24. The computer readable medium of claim 21, wherein said authorizing slave set-top device step comprises communicating an authorization key to said slave set-top device.

25. The computer readable medium of claim 21, wherein said communicating an authorization key to said slave set-top device comprises communicating an authorization key to said slave set-top device via DiSEqC signaling.
